(19) United States
(12) Patent Application Publication
(10) Pub. No.: US 2002/0139549 A1
(43) Pub. Date: Oct. 3, 2002

(54) Diesel pile hammer

(76) Inventor: Stefan Mewes, Esslingen (DE)

Correspondence Address: FACTOR & PARTNERS, LLC, 1327 W. WASHINGTON BLVD., SUITE 5G/H, CHICAGO, IL, 60607, US

(21) Appl. No.: 10/112,981

(22) Filed: Mar. 29, 2002

(30) Foreign Application Priority Data
Mar. 29, 2001 (DE) 101 15 682.0

(51) Int. Cl. B25D 9/00

(52) U.S. Cl. 173/114

(57) ABSTRACT

In this diesel pile hammer, the cylinder carries a means for cleaning the combustion gases. This means is connected to a working passage in the cylinder via a valve and an exhaust gas/fresh air changeover device.

The invention relates to a diesel pile hammer as detailed in the preamble of claim 1.

Diesel pile hammers of this kind of different designs are used for driving standard piles and sheet piles and the like into the ground. They generally have one or more working slots distributed in the circumferential direction that act both as an inlet for combustion air and an outlet for combustion gases. In the cylinder that has the working slots in its circumferential wall runs a piston that, together with the circumferential wall of the cylinder and an anvil that is mounted to be displaceable at the bottom end of the cylinder, defines a combustion chamber. Fuel (diesel oil) can be injected into this combustion chamber by an injection pump carried by the circumferential wall of the cylinder.

This takes place under the control of the falling movement of the piston in such a way that a preset quantity of fuel is sprayed onto the top end-face of the anvil shortly before the point in time at which the piston strikes the top face of the anvil. When it strikes, the fuel is then atomized and ignited in the air that has been heated by compression. Having first been started, for which purpose the piston is raised by a mechanical starting device and then allowed to drop, a diesel pile hammer thus operates in a similar way to a port-controlled two-stroke engine.

The circumferential wall of the cylinder also carries a lubricating device that supplies the working faces of the cylinder with lubricating oil. Because of the large moving masses in the two-stroke diesel engine that forms the diesel pile hammer, the rough conditions in which it operates and the sometimes inconsistent running conditions in it, the combustion gases that it emits often still contain liquid components (fuel residues, condensate and solid components (soot and other particles).

For many applications, and particularly for the use of diesel pile hammers in the vicinity of populated areas, it would be desirable if the combustion gases could be freed of liquid and/or solid components.

To allow this object to be achieved, a diesel pile hammer having the features specified in claim 1 is provided by the present invention.

Advantageous refinements of the invention are specified in the subclaims.

If, in accordance with claim 3, use is made of a separator for liquid or condensed components of the combustion gases that has a plurality of separating plates placed in the flow path of the combustion gases, then this separator is of very rugged construction and its efficiency does not decline over time because it operates on the precipitation principle rather than the filtration principle.

With the refinement of the invention according to claim 4, what are obtained are large precipitation areas for liquid and/or condensed components with compact dimensions for the separator. What is more, the resistance to flow of the separator is relatively low.

The refinement of the invention according to claim 5 provides good contact between the combustion gases and the separating surfaces of the separating plates. In this way, high efficiency is achieved in removing liquid and condensable components of the combustion gases.

The refinement of the invention according to claim 6 has the advantage on the one hand that there is relatively low resistance to flow in the separator for combustion gases but on the other hand that there is intimate contact between the combustion gases and the separating surfaces.

The refinement of the invention according to claim 7 is of advantage in view of the fact that the liquid components that are separated out are conducted satisfactorily to the bottom section of the separator under the prompting of gravity. What is more, the orientation specified for the individual openings in the ribbed interwoven metal mesh is of advantage in that in this way the individual separating plates are particularly easy to insert in a casing that surrounds the arrangement of separating plates.

The refinement of the invention according to claim 8 is of advantage in respect of easier fitting and removal of the separating plates. Removal of this kind may for example be undertaken at intervals, when it is desired to clean off stubborn deposits that have formed on the separating plates in the course of time, using a steam-jet device or the like.

If the casing of the separator for liquid and/or condensable components is designed in the manner specified in claim 9, then the combustion gases are in contact with the separating plates for a distance that is as long as possible.

What is achieved by the refinement of the invention according to claim 10 is that, when the separating plates are aligned in the casing of the separator parallel to the latter's sidewalls, there is still a tilt between the planes of the separating plates and the direction of flow of the combustion gases.

The refinement of the invention according to claim 11 ensures that the different separating plates that are situated in the interior of the casing of the separator make substantially equal contributions to separating out liquid and/or condensable components.

In a diesel pile hammer according to claim 12, the liquid and/or condensable components of the combustion gases that are separated out collect at a single point in the separator casing.

In a diesel pile hammer according to claim 13, the liquid and/or condensable components that are separated out are directed to a point to which operating personnel have easy access to allow the components that are separated out to be withdrawn at intervals.

Dimensions for the separating plates such as are specified in claim 14 have proved particularly successful in practice. Separating plates so sized are sufficiently rugged mechanically to have long installed lives under the rough conditions in which a diesel pile hammer operates but on the other hand are sufficiently fine to allow the combustion gases to pass through them with intimate contact between the gases and the separating plates.

A diesel pile hammer such as is specified in claim 15 also carries only a few units separately mounted on the outside surface of its cylinder because the separator for liquid and/or condensable components and a fuel tank together form a single separately fitted unit.

In a diesel pile hammer according to claim 16, solid components too are removed from the combustion gases.

When this is the case, the refinement of the invention according to claim 17 ensures that particles and liquid and/or condensable components do not bake, on the filter medium of the particle separator, into a pasty layer that soon clogs the filter medium. In a diesel pile hammer according to claim 17, the solid components are separated out on the filter medium of the particle separator in a substantially dry state. Given the violent concussions to which the entire diesel pile hammer is subject when the hammer is operating, the filter medium of the particle separator is subject to the same concussions, and the particles that are separated out in the dry state thus drop off the filter medium satisfactorily. Hence the latter needs to be replaced only at relatively long intervals.

If there is provided for the particle separator a casing such as is specified in claim 18, then the casing is mechanically simple in construction, supports the filter element well and allows the filter element to be inserted and removed easily.

The refinement of the invention according to claim 19 is of advantage in respect of having the largest possible area of filter surface in the particle separator with compact dimensions.

The refinement of the invention according to claim 20 is of advantage in respect of a long installed life for the filter element under the operating conditions on a diesel pile hammer.

The refinement of the invention according to claim 21 has the advantage on the one hand that the space inside the filter element can be connected easily to the inlet opening for the combustion gases to be cleaned simply by placing the filter element over that end-wall of the separator which contains the inlet, and on the other that the element can be inserted into and removed from the separator casing easily without the end-wall having to be taken off.

The refinement of the invention according to claim 22 is of advantage in respect of the collecting of any additional residual liquid and/or condensable components of the combustion gases that may be separated out in the solids separator.

In this case, in a diesel pile hammer according to claim 23, the liquid and/or condensate that are separated out are once again taken to a point that is easily accessible to the operating personnel.

What is achieved by the refinement of the invention according to claim 24 is that this diesel pile hammer cannot draw in combustion air through the exhaust gas cleaning means.

In a diesel pile hammer according to claim 25, the working chamber in the diesel pile hammer is connected to the ambient atmosphere, to allow combustion air to be fed in without the use of moving parts.

When this is the case, what is achieved by the refinement of the invention according to claim 26 is that the resistance to flow of the changeover device by which the working port of the cylinder can be connected alternatively to the ambient atmosphere and the exhaust gas means is smaller in the direction of the exhaust gas cleaning means than in the direction of the ambient atmosphere because the combustion gases are not subject to any change in their direction of movement in the changeover device but the combustion air that is drawn in there is subject to a sharp change in direction.

The refinement of the invention according to claim 27 is of advantage in view of the fact that, in the changeover device, all the combustion gases are transferred to the exhaust gas means. Due to the enlargement of cross-section at the upstream end of the tubular part compared to the end of the working passage that is formed in the cylinder, entrainment of fresh air occurs due to a water-jet pump effect and there is no escape of combustion gases.

If the valve that is connected upstream of the exhaust gas cleaning means is designed in accordance with claim 28 as a flap valve or plate valve, then this valve will open easily in the direction of the exhaust gas cleaning means but will reliably prevent combustion air from being drawn in through the exhaust gas cleaning means.

In a diesel pile hammer according to claim 29, positive control of the combustion air is obtained in accordance with the phase reached at the time in the operating cycle of the diesel pile hammer.

According to claim 30, the positive control of the combustion air once again takes place with low inertia and with a resistance to flow that is low in the opening direction.

The refinement of the invention according to claim 31 provides feedback of exhaust gas in a mechanically simple manner. In this way any combustible components that the combustion gases may still contain can easily be fed for recycling.

### BRIEF DESCRIPTION OF THE DRAWING

The invention will be explained in detail below by reference to embodiments and to the drawings. In the drawings:

FIG. 1 is a side view of a diesel pile hammer having a means for cleaning the combustion gases,

FIG. 2 is an enlarged view in axial section of the bottom section of the diesel pile hammer shown in FIG. 1, in the phase where the combustion gases are expelled,

FIG. 3 is a view similar to FIG. 2 showing the conditions on the intake stroke of the diesel pile hammer,

FIG. 4 is a schematic perspective view of a first separator for the diesel pile hammer shown in FIG. 1, which is used for separating out liquid and/or condensable components of the combustion gases,

FIG. 5 is a schematic perspective view of a second separator of the diesel pile hammer shown in FIG. 1, which is used to separate out soot particles and other solid components contained in the combustion gases.

FIG. 6 is a view of a cylinder slot through which a pawl of a starting device can be moved, and

FIG. 7 is a view similar to FIG. 1 showing a modified diesel pile hammer.

### DETAILED DESCRIPTION OF THE DRAWINGS

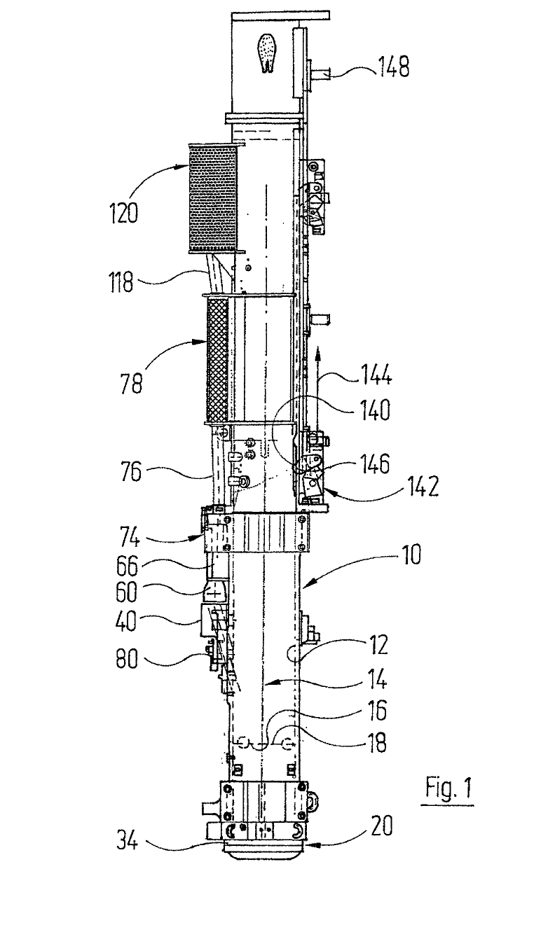

The diesel pile hammer shown in FIG. 1 has a cylinder referred to generally as 10 that has a working surface 12. Movable within the cylinder 10 is a piston 14 that is only indicated in broken lines in FIG. 1. Piston 14 is shown in FIG. 1 in a down position in which a bottom end-face 16 of piston 14 is just resting against a top end-face 18 of an anvil 20.

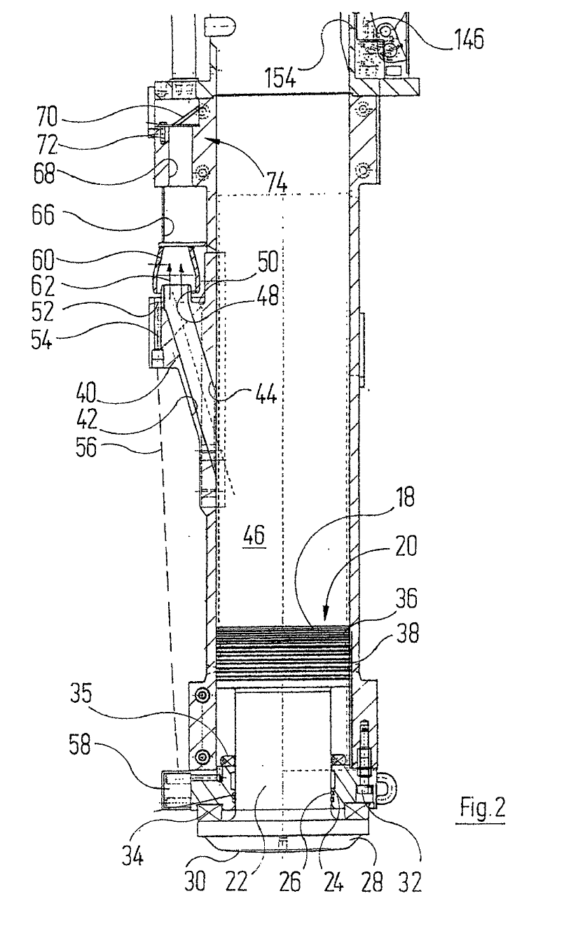

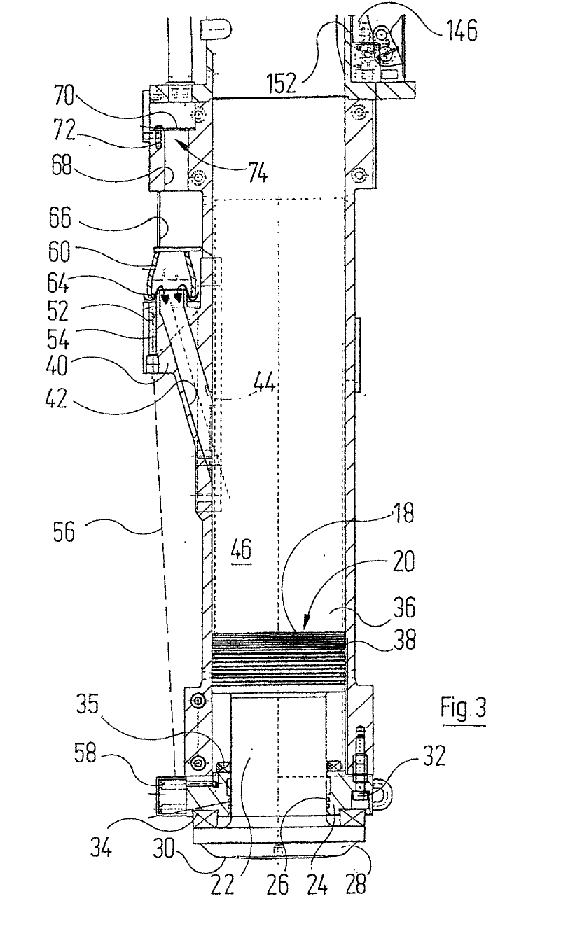

As can be seen from FIGS. 2 and 3, the anvil 20 has a central shank section 22 which is guided in a sleeve-like end portion 24 of the cylinder and which is sealed against the inside of the latter by seals 26.

A bottom head-section 28 of anvil 20 has a curved bottom end-face 30 that, either directly or via a cushion head (not shown) cooperates with the top end of an item to be driven (e.g. a sheet pile or a concrete pile).

The cylinder end-piece 24 is connected to the bottom end of cylinder 10 by bolts 32. A damping ring 34 is provided between the opposing end-faces of cylinder end-piece 24 and the head section 28 of the anvil 20.

A further damping ring 35 comes into action when the bottom face of a piston section 36 of the anvil 20 is moved towards the top face of the end-piece 24 of the cylinder.

The piston section 36 at the top of the anvil 20 carries a plurality of sealing rings that succeed one another in the axial direction and that co-operate with the working surface 12.

Provided in a lateral projection 40 on cylinder 10 is a working passage 42 that is inclined at an angle of approximately 17° to the axis of cylinder 10. The end of working passage 42 that is situated in working face 12 forms a working port 44 by which, in conjunction with the bottom end of piston 14, access to a working chamber 46 in the diesel pile hammer is controlled, which chamber is defined by piston 12, anvil 20 and working face 12.

A top section 48 of working passage 42 projects upwards from projection 40 from the cylinder in a sleeve-like form, parallel to the axis of cylinder 10.

Provided in the top face of the projection 40 from the cylinder is an annular channel 50 that surrounds section 48 of the passage. This channel 50 is connected to a drain bore 52 that can be closed off by a drain screw 54 (as shown) or that can be connected via a fitting to a drain line 56 (shown in broken lines) that leads to a collecting chamber 58 for liquid that is provided at the bottom end of cylinder 10.

The sleeve-like cylindrical section 48 of the passage is also surrounded co-axially by a bell-like, frustoconical tubular member 60 that overlaps section 48 of the passage axially, though there is an interstice left between the outer face of section 48 of the passage and the inner face of tubular part 60 and between the bottom edge of tubular part 60 and the top face of projection 40 from the cylinder. The diameter of the top section of tubular part 60 is substantially the same as the diameter of section 48 of the passage.

In the compression phase of the two-stroke diesel engine formed by cylinder 10 and piston 14, combustion gases flow out through working passage 42 and into the interior of tubular part 60, as indicated by arrows 62.

In the intake phase of the diesel pile hammer on the other hand combustion air flows through the gap defined by section 48 of the passage and tubular part 60, as indicated by arrows 64 in FIG. 3.

The combustion gases 62 are directed by tubular part 60 into a buffer chamber 66 that is separately fitted to the outer face of cylinder 10. From there the combustion gases pass through a valve passage 68 to a flap-valve member 70 that is formed in the present case by a valve-tongue held by a screw 72. It could however also be a rigid flap with a hinged joint.

From the check valve 74 formed by valve passage 68 and flap-valve member 70, the combustion gases pass via a duct 76 to a first separator that is referred to generally as 78, in which liquid and condensable components are extracted from the combustion gases.

Two sets of the components 40-76 described above are provided on cylinder 10 with a 90φ offset between them in order to ensure that there are adequate inflow and outflow cross-sections for working chamber 46.

In line with this, an injector unit 80 that is only schematically indicated in FIG. 1 can emit jets of fuel from two injection nozzles that are offset from one another by 180° or 90° in the circumferential direction, as is known per se.

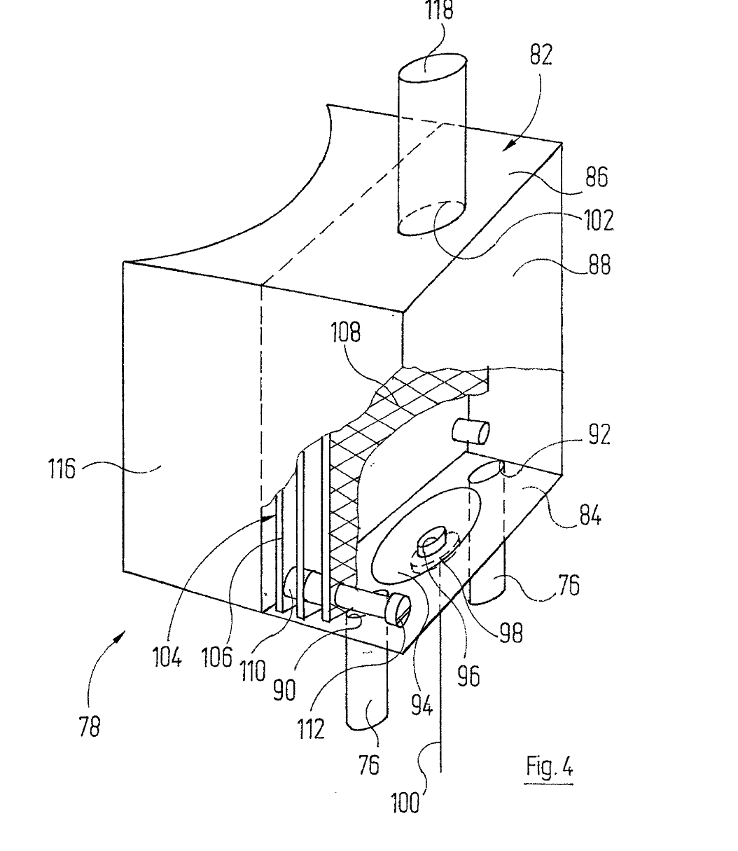

As can be seen from FIG. 4, the first separator 78 has a casing referred to generally as 82 having a bottom wall 84, a top wall 86 and a circumferential wall 88 of rectangular cross-section situated therebetween.

Provided in bottom wall 84 are two connecting openings 90, 92 that connect up with the two ducts 76. The connecting openings 90, 92 are situated at the extreme left-hand and extreme right-hand edges respectively of bottom wall 84. Between connecting openings 90, 92, there is a depressed section 94 of bottom wall 84 that extends downwards in a conical shape and that is connected to a drain opening 96 for the liquid and condensate that are separated out.

The drain opening 96 may be closed off by a screw 98, which is removed at intervals to allow the contents of the sump formed by the depressed section of wall to be drained off. Alternatively, the drain opening 96 may, as indicated in broken lines, be connected by a duct 100 to the collecting chamber 58 for liquid that is provided at the bottom end of cylinder 10.

The top wall 86 of separator casing 82 has a single outlet opening 102 for combustion gases.

Arranged in the interior of separator casing 82, which is substantially in the form of a right parallelepiped, is a stack, referred to generally as 104, of separating plates 106. The separating plates 106 are each made of ribbed interwoven metal mesh, as indicated by some of the apertures that are shown by way of illustration at 108. The apertures 108 in the mesh are diamond-shaped and are so aligned that their long diagonal is parallel to the axis of the cylinder, which in operation is substantially coincident with the vertical.

In practice, the separator plates 106 of ribbed interwoven metal strips have apertures whose maximum length is between 10 and 30 mm and preferably between 15 and 22 mm, whereas the minor axis of the apertures is between 5 and 15 mm and preferably between 8 and 10 mm. The width of the divisions between the openings is between 1 and 3 mm and is preferably approximately 1.5 mm. The thickness of the divisions is between approximately 0.5 and approximately 2 mm and preferably between 1 and 1.5 mm. The overall thickness of an individual separator plate is in the range between approximately 1 and 5 mm and preferably between 2 and 3 mm. In practice, the spacing between separating plates 106 arranged next to one another in parallel is approximately 3 to 15 mm and preferably approximately 8 to 12 mm.

The individual separating plates 106 are spaced apart by suitable spacer sleeves 110 that are inserted between adjacent separating plates 106 and through which extend studs 112 by which the separating plates 106 are assembled into a stack of plates 104 that can be handled as a single unit.

If desired, as a modification of the embodiment shown in the drawing, the separator plates 106 may also be provided with a corrugation that is larger than the spacing between the plates, thus giving even more intimate contact between the combustion gases and the surfaces of the separating plates.

However, because the connecting openings 90, 192 are offset laterally from the outlet opening 102, even when the geometry of the separating plates 106 is flat a flow component is obtained in a direction perpendicular to the plane of the separating plates 106.

The separator casing 82 is joined to a fuel tank 116 in such a way that what is obtained is a smooth-faced external contour. The inward face of the fuel tank 116 is matched to the curvature of the outside face of cylinder 10, as can be seen from FIG. 4.

The outlet opening 102 from the first separator 78 is connected via a duct 118 to a second separator 120 that filters soot and other solid components out of the combustion gases.

Separator 120 has a casing that is referred to generally as 122 and that has a bottom end-wall 124 that is connected to the outlet end of duct 118, a top end-wall 116 and a circumferential wall 128 lying therebetween. Provided in circumferential wall 128 are a large number of circular openings 130. The top end-wall 126 contains a large opening 132.

Housed in the interior of casing 122 is a filter element referred to generally as 134. The latter has a circumferential wall 136 folded in a zigzag pattern that is composed of a woven plastics fabric that is provided with a coating of porous plastics material. The pores in filter element 134 are selected to be such that 95% of the particles that have a diameter of 0.4 μm or more will be removed from a flow of gas passing through the filter material.

The circumferential wall 136 formed by the filter material folded in a zigzag pattern is closed off at the top end by a wall of paper 138 or the like that is impermeable to gas.

The diameter of opening 132 is selected to be slightly smaller than the outside diameter of filter element 134 so that the filter element 134 can, by being compressed, be moved through opening 132 but in the unstressed state is retained in the casing 122 by the edge of opening 130. Combustion gases containing soot and other solid particles then impinge on the interior of filter element 134 from the end of duct 118 and then pass through the circumferential wall 136 of filter element 134 (and subsequently through the circumferential wall 128 of casing 122) in the radial direction and as they do so leave behind the solid components contained in them.

Due to the severe shock loads to which the diesel pile hammer is subject in active operation, the filter element 134 is shaken powerfully and as a result particles that are separated out on the inside of the element drop off and collect across the bottom end-wall 124 of casing 122. From there the solid components that have been separated out can be taken away at intervals, where appropriate at the same time as the filter element 134 is replaced, as it has to be anyway at fairly long intervals.

Separators 78 and 120 are arranged one above the other in line axially on the outside of cylinder 10.

In FIG. 1, there is shown at 140 a shoulder 140 on the piston 14 by which the piston 12 is taken hold of to allow the diesel pile hammer to be started and is lifted up by a mechanical starting device. This mechanical starting device comprises a coupling head 142 that can be displaced in the vertical direction by a drive means indicated by an arrow 144, e.g. a wire rope or a hydraulic lifting cylinder.

The drive head 142 comprises a pawl 146 able to pivot about a horizontal axis that cooperates with shoulder 140 and that can be moved from the working position shown in the drawing to a freed position in which the piston 14 is released and for which provision is made at a preset height on cylinder 10.

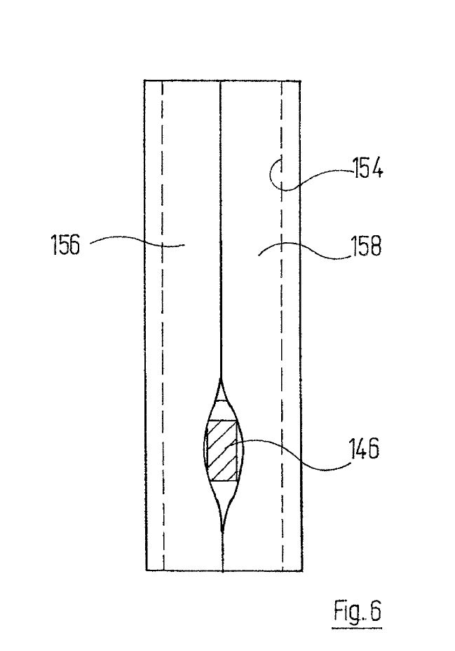

If desired, it is also possible for there to be provided on cylinder 10 a movable stop 150 (see FIG. 6) which can be connected as desired to different fixing holes 152 in cylinder 10 to enable the height of drop of piston 14 when starting to be made smaller than that preset by stop 148 to suit the soil conditions at the time.

To enable pawl 146 to carry shoulder 140 along with it, cylinder 10 has a suitable longitudinal slot 154 parallel to its axis (see FIGS. 2, 3 and 6).

To stop combustion gases from escaping through the longitudinal slot 154, the latter is closed off by two sealing lips 156, 158 in strip form that in the unloaded state either butt together or overlap slightly in the circumferential direction. By spreading the sealing lips 156, 158 apart locally, pawl 146 can be moved in longitudinal slot 154 but the corresponding section of the working surface 12 still remains substantially gastight.

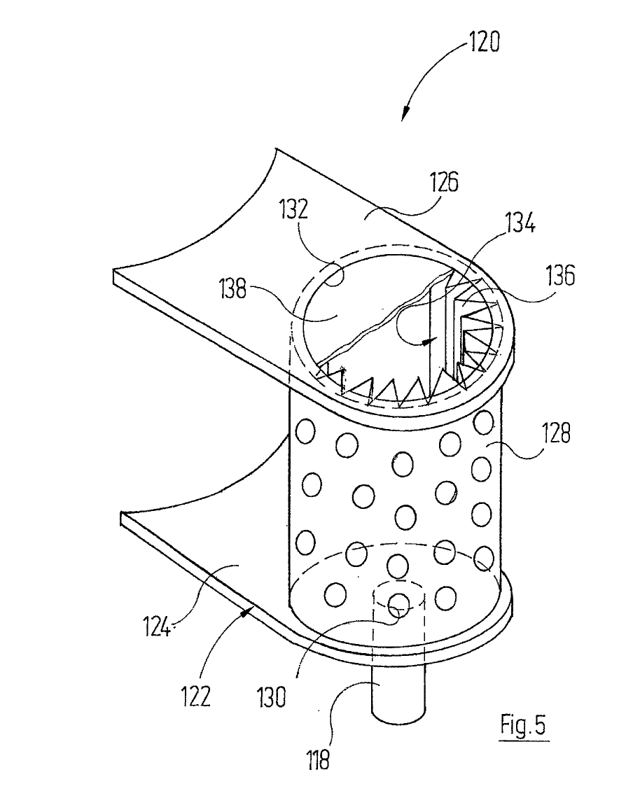

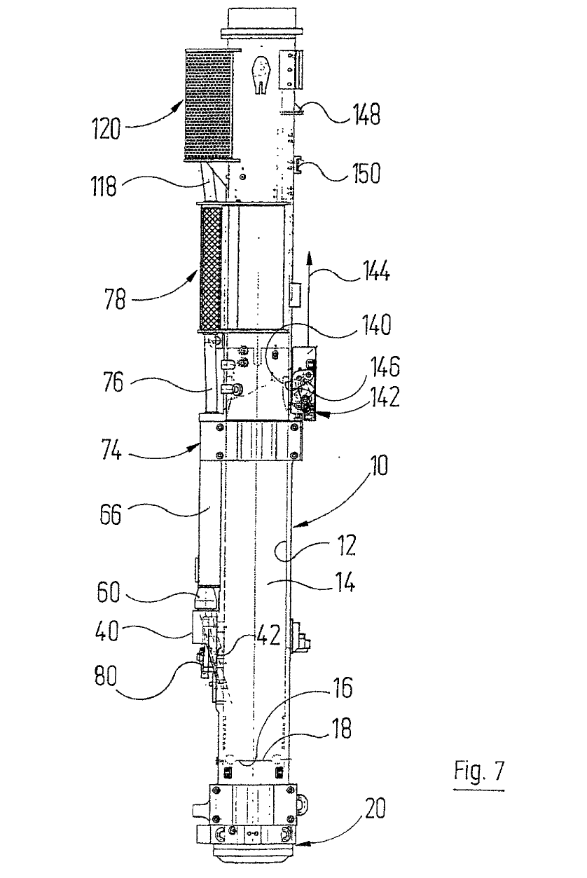

The modified embodiment shown in FIG. 7 differs from that shown in FIGS. 1 to 5 in that a buffer chamber 66 of larger volume is provided. Because buffer chamber 66 lies upstream of check valve 74, in a diesel pile hammer as shown in FIG. 7 there is a greater feedback of exhaust gases than in the embodiment shown in FIGS. 1 to 6.

The diesel pile hammers described above operate as follows:

Fuel injected into working chamber 46 having been ignited when piston 14 struck the top face of anvil 20, piston 14 is thrust upwards. Combustion gases first flow out via working passage 42, tubular part 60 and buffer chamber 66 and via check valve 74 into first separator 78. There the combustion gases flow along the surfaces of separating plates 106 and as they do so they lose the liquid and condensable components contained in them.

Having been freed of their liquid and condensable components, the combustion gases flow via duct 118 into the second separator. The combustion gases flow into filter element 134 axially and then change their direction of flow, because filter element 134 is closed off at the top by the wall of paper 138, and flow through the circumferential wall 136 of filter element 134, which is folded in a zigzag pattern, in the radial direction. Soot particles and other particles of solid matter contained in the combustion gases are then retained as the gases do so.

Due to its kinetic energy, piston 14 continues to rise in cylinder 10 even when the pressure in working chamber 46 has already dropped to atmospheric pressure. In the course of this continuing upward movement of piston 14, a pressure below atmospheric is then generated in working chamber 46 and ambient air is drawn in through the throttling gap defined by tubular part 60 and section 48 of working passage 42. Because of the pressure below atmospheric generated in working passage 42, flap-valve member 70 is then moved to the closed position, as shown in FIG. 3.

The drawing in of combustion air comes to an end as piston 14 reaches its top dead center.

As piston 14 then drops down, working port 44 is closed off by the circumferential surface of the piston and as from this point on the downstroke the air in working chamber 46 is compressed, in the course of which it heats up. As the piston 14 continues to fall, injection unit 80 is then actuated and a preset amount of fuel is sprayed onto the top end-face of anvil 20.

When piston 14 strikes the top end-face 18 of anvil 20, it surrenders its kinetic energy to anvil 20. The latter is forced down in this way and in turn drives the item to be driven with which it co-operates into the ground.

At the same time as piston 14 strikes anvil 20 the fuel situated on the latter is ignited and the cycle described above is repeated.

From the above description it can be seen that the diesel pile hammers according to the invention can continue to operate as two-stroke diesel engines but it is possible nevertheless for the combustion gases to be cleaned. The liquid and condensable components are removed from the gases in separator 78 and the solid components, and particularly soot particles, are removed in separator 120.

In this case tubular part 60, passage section 48 and check valve 74 together form a unit that ensures that combustion air is fed to working chamber 46 straight from the ambient atmosphere, whereas combustion gases are only released into the surroundings when they have first passed through separators 78 and 120.

The exhaust gas means provided in accordance with the invention for a diesel pile hammer is of simple mechanical construction and is sufficiently rugged to withstand the shock loads that occur when a diesel pile hammer is operating, even in long-term operation. The exhaust gas cleaning means is easy to maintain and is easy to clean too when required. It is compact in construction and enlarges the clear dimensions of the diesel pile hammer only slightly.

The following further modifications may be made:

The bottom end-wall 124 of the casing 122 of the separator 120 for solid components of the combustion gases may contain a depression that is connected to a drain opening to enable any residual liquid components that may arise in separator 120 to be drained off.

This drain opening may be connected in turn, via a drain duct 160, to the collecting chamber 58 that is situated at the bottom end of cylinder 10.

Working slot 44 may be connected to the ambient atmosphere by a fresh-air valve situated upstream of exhaust gas valve 74, in which case the fresh-air valve may be a flap valve or a disk valve whose closure member is preloaded to the closed position by weight and/by resilient force.

What is claimed is:

1. A diesel pile hammer having a cylinder and having a piston running in the cylinder and a fuel injecting means, the cylinder being provided with at least one working opening via which combustion air is fed in and/or combustion gases are fed out, characterized in that a means for cleaning exhaust gases is connected to a least one working opening via which combustion gases are fed out.

2. The diesel pile hammer according to claim 1, characterized in that the exhaust gas cleaning means has a separator for liquid and/or condensable components of the combustion gases.

3. The diesel pile hammer according to claim 2, characterized in that the separator for liquid and/or condensable components of the combustion gases has a plurality of separating plates which are placed in a flowpath that extends between at least one inlet and at least one outlet of the separator.

4. The diesel pile hammer according to claim 3, characterized in that at least some of the separating plates are placed parallel to one another.

5. The diesel pile hammer according to claim 3, characterized in that at least some of the separating plates are inclined to the direction of flow of the combustion gases.

6. The diesel pile hammer according to claim 1, characterized in that at least some of the separating plates are perforated plates or plates of ribbed expanded metal mesh.

7. The diesel pile hammer according to claim 6, characterized in that in the separating plates made from ribbed expanded metal mesh the individual apertures in the mesh are diamond-shaped and the major axes of the apertures extend parallel to the axis of the cylinder.

8. The diesel pile hammer according to claim 3, characterized in that, by inserting spacer members between them, the separating plates are connected into a stack of plates that can be handled as a single unit.

9. The diesel pile hammer according to claim 3, characterized in that a casing of the separator for liquid and/or condensable components of the combustion gases has a first end-wall transverse to the axis of the cylinder and, spaced therefrom, an end-wall which is likewise transverse to the axis of the cylinder, at least one inlet for combustion gases being provided in the first end-wall and at least one outlet for combustion gases being provided in the second end-wall.

10. The diesel pile hammer according to claim 9, characterized in that the number of inlets differs from the number of outlets.

11. The diesel pile hammer according to claim 10, characterized in that the inlets and outlets of the separator for liquid and/or condensable components of the combustion gases are arranged symmetrically to a longitudinal center plane of the separator casing.

12. The diesel pile hammer according to claim 9, characterized in that a lower one of the end-walls of the separator casing has a depressed central section that is connected to a drain opening.

13. The diesel pile hammer according to claim 12, characterized in that the drain opening is connected via a drain duct to a collecting chamber that is provided at the bottom end of the cylinder.

14. The diesel pile hammer according to claim 3, characterized in that the thickness of the separating plates is approximately 1 to 5 mm and preferably approximately 2 to approximately 3 mm, in that the spacing between the separating plates is between approximately 3 to 15 mm and is preferably approximately 8 to 12 mm, in that the apertures in the mesh each have a major dimension of approximately 10 to 30 mm and preferably approximately 15 to 22 mm and a minor dimension of 5 to 15 mm and preferably approximately 8 to 10 mm, in that the width of the divisions between the apertures is approximately 1 to 3 mm and is preferably approximately 1.5 mm and in that thickness of the divisions between the apertures in the mesh is approximately 0.5 to 2 mm and preferably approximately 1 to 1.5 mm.

15. The diesel pile hammer according to claim 2, characterized in that the casing of the separator for liquid and/or condensable components of the combustion gases and a fuel tank are joined together to form a unit.

16. The diesel pile hammer according to claims 1, characterized in that the exhaust gas cleaning means has a separator for solid components of the combustion gases and particularly for soot particles.

17. The diesel pile hammer according to claim 16, characterized in that the separator that removes solid components is arranged downstream of the separator that removes liquid and/or condensable components and in the exhaust gas cleaning means has a separator for liquid and/or condensable components of the combustion gases.

18. The diesel pile hammer according to claim 16, characterized in that the separator for solid components has a casing that has a circumferential wall provided with openings, and comprises a filter element that has a circumferential wall made of filter material.

19. The diesel pile hammer according to claim 18, characterized in that the filter element has a circumferential wall that is folded in a zigzag pattern.

20. The diesel pile hammer according to claim 19, characterized in that the filter element has a woven filter fabric that is preferably coated with porous material.

21. The diesel pile hammer according to claim 20, characterized in that an end-face of the filter element is closed off with a gastight seal and an end-wall of the separator casing has an opening through which the filter element can be moved.

22. The diesel pile hammer according to claim 16, characterized in that a bottom end-wall of the casing of the separator for solid components of the combustion gases has a depression that is connected to a drain opening.

23. The diesel pile hammer according to claim 22, characterized in that the drain opening is connected via a drain duct to a collecting chamber that is situated at the bottom end of the cylinder.

24. The diesel pile hammer according to claim 1, characterized in that a valve that opens in the direction of the exhaust gas cleaning means is provided between the working port and the exhaust gas cleaning means.

25. The diesel pile hammer according to claim 24, characterized in that the working port is connected to the ambient atmosphere via a throttling slot situated upstream of the valve.

26. The diesel pile hammer according to claim 25, characterized in that the throttling slot is defined by the free end of a tubular part that leads to the exhaust gas cleaning means and by a projection on the cylinder in which is formed a working passage that presets the working port.

27. The diesel pile hammer according to claim 26, characterized in that the tubular part widens out in a conical shape in the direction of the working port and the end of the tubular part that is adjacent the working port is larger in diameter than the adjacent end of the working passage.

28. The diesel pile hammer according to claim 24, characterized in that the valve is a flap valve or leaf valve that is preloaded into the closed position by the weight of its closure member and/or by resilient force.

29. The diesel pile hammer according to claim 24, characterized in that the working port is connected to the ambient atmosphere via a fresh-air valve situated upstream of the exhaust gas valve.

30. The diesel pile hammer according to claim 29, characterized in that the fresh-air valve is a flap valve or leaf valve whose closure member is preloaded into the closed position by weight and/or by resilient force.

31. The diesel pile hammer according to claim 1, characterized by a buffer chamber connected upstream of the exhaust gas cleaning means.
